(19) United States
(12) Patent Application Publication
(10) Pub. No.: US 2008/0073152 A1
(43) Pub. Date: Mar. 27, 2008

(54) TOWER SHAFT (UTS) SHIELDING

(75) Inventors: Andreas ELEFTHERIOU, Woodbridge (CA); David DENIS, Burlington (CA)

Correspondence Address: OGILVY RENAULT LLP (PWC), 1981 MCGILL COLLEGE AVENUE, SUITE 1600, MONTREAL, QC, H3A 2Y3, US

(73) Assignee: PRATT & WHITNEY CANADA CORP., Longueuil (CA)

(21) Appl. No.: 11/534,698

(22) Filed: Sep. 25, 2006

(51) Int. Cl. F16H 57/04

(52) U.S. Cl. 184/6.12

(57) ABSTRACT

An oil shield for an upper tower shaft gear. The shield provides a plurality of shield members for encapsulating the upper tower shaft gear to reduce the amount of displaced oil from contacting surrounding engine components. The shield includes a first shield member adjacent a top surface of the upper tower shaft gear and a second shield member adjacent an under surface of the upper tower shaft gear which is engaged with the first shield member to enclose the upper tower shaft gear. A third shield member is positioned adjacent the second shield member. The shield members permit oil drainage in a predetermined pattern without undesirable dispersion within the engine compartments.

### TECHNICAL FIELD

The invention relates generally to an oil shield arrangement and, more particularly, to an improved oil shield which facilitates predetermined oil dispersion within an upper tower shaft of an aircraft.

### BACKGROUND OF THE ART

Generally speaking, oil shielding is an important feature in an aircraft engine and in particular in a tower shaft gear system which communicates with the accessory gear box and the angle drive gear box. One of the difficulties in shielding the oil in these arrangements is the unwanted oil dispersion, or splashing or misdirection from windage.

In prior designs, a segment of metal was bent and bolted to a suitable location within the angle drive gear box for preventing dispersion of oil from the upper tower shaft gear being displaced elsewhere within the engine compartment. As is known, the unwanted dispersion or erratic drainage of oil within an engine compartment can coat or otherwise layer surfaces having high temperature which, subsequently leads to overheating or damage of critical components. Obviously this can have very significant effects on the operation of the engine and such problems typically escalate and cascade into very serious problems rapidly.

Accordingly, there exists a need for an oil shield in this environment which is capable of providing containment and predetermined drainage of oil within the upper shaft gear to mitigate the limitations of the guard or shield arrangements previously employed in the art. The present invention is directed to mitigating the problems associated with the prior art arrangements.

Accordingly, there is a need to provide an improved oil shield and method of using the shield.

### SUMMARY OF THE INVENTION

In one aspect, the present invention provides an oil shield for an upper tower shaft gear, comprising: a plurality of shield members for encapsulating said upper tower shaft gear to reduce the amount of displaced oil from contacting surrounding engine components, said shield members including: a first shield member adjacent a top surface of said upper tower shaft gear; a second shield member adjacent an under surface of said upper tower shaft gear and engaged with said first shield member to enclose said upper tower shaft gear; and a third shield member adjacent said second shield member, said shield members for draining oil in a predetermined pattern.

In another aspect, the present invention provides a method of shielding oil dispersion within an upper tower shaft gear of an aircraft engine, comprising: providing a plurality of discreet cooperatively engageable shield members; encapsulating said upper tower shaft gear by positioning said shield members about said upper tower shaft gear; and securing said cooperatively engageable shield members together to provide an oil shield having a predetermined drain pattern.

Further details of these and other aspects of the present invention will be apparent from the detailed description and figures included below.

### DESCRIPTION OF THE DRAWINGS

Reference is now made to the accompanying figures depicting aspects of the present invention, in which:

FIG. 1 is a partial cross section of an upper tower shaft gear and the prior shield design;

FIG. 2 is a partially cut away section view of the shield arrangement of the present invention.

### DETAILED DESCRIPTION OF THE PREFERRED EMBODIMENTS

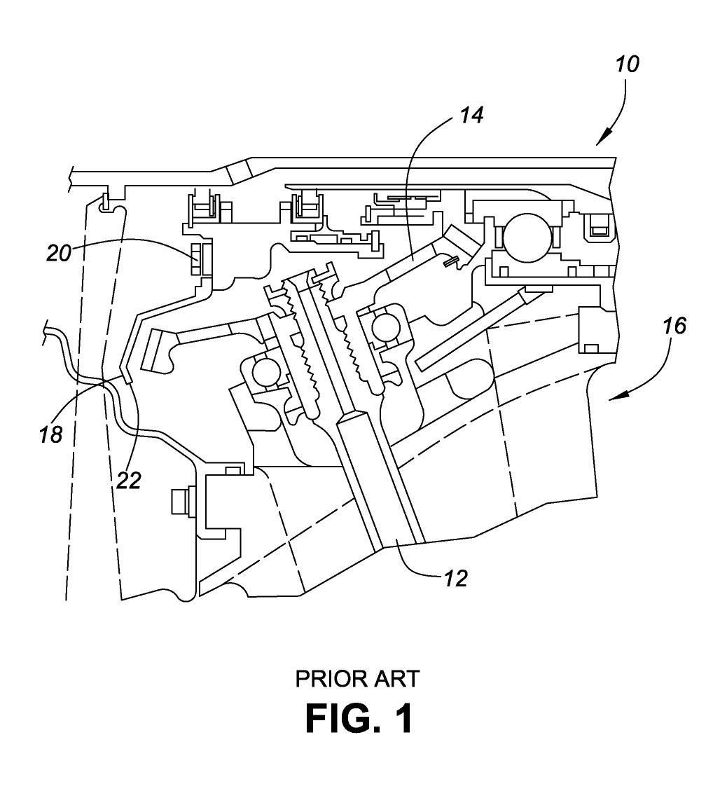

FIG. 1 illustrates a prior art arrangement globally denoted by numeral 10 where a section of an upper tower shaft 12 having a tower shaft gear 14 is disposed generally within the angle drive gear box, globally denote by numeral 16. Disposed within the gear box is an oil shield 18, which shield is bolted at 20 within the angle gear box 16. The prior art shield design includes a formed section of metal where the configuration of the shield is such that it is in spaced relation to the orbit of the gear 14 and subscribes to a shape which is complimentary to the gear 14. A lip 22 is provided for at the terminal end of the shield 18, which end is the opposite end to point at which the shield is mounted at 20 within the angle gear box. This configuration is useful to prevent unwanted dispersion of oil by tangential dispersion during rotation of gear 14. The result is that the tangential oil contacts the guard and is redirected via the lip 22 into the gear box 16.

As discussed herein previously, this arrangement is tantamount to a deflector or guard and does not provide for any real containment of unwanted dispersion which leads to deposit and/or loss of oil which subsequently can lead to mechanical failure, overheating, etc.

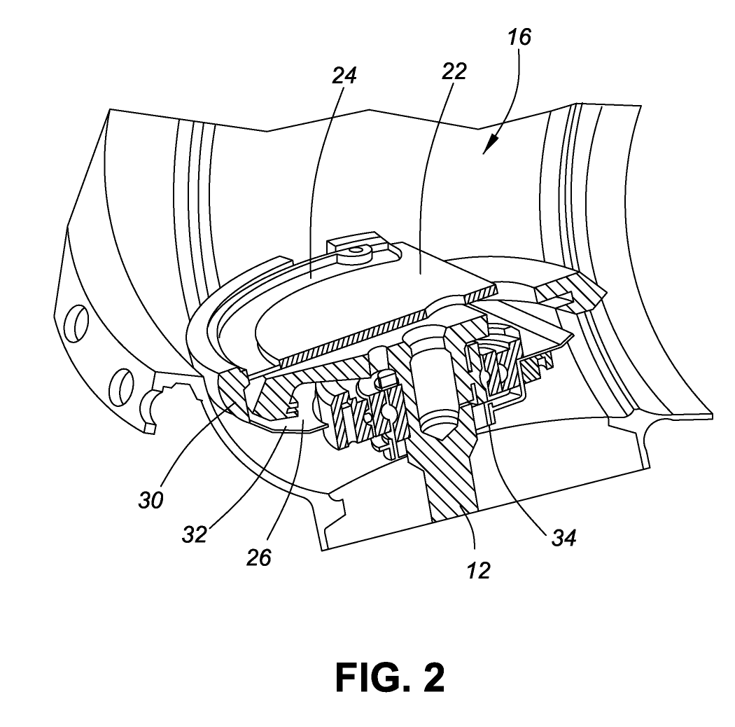

With respect to FIG. 2 shown is the shield arrangement of the present invention. In the figure, the arrangement includes a plurality of discreet individual shield members which substantially encapsulate the gear 14. The shield members include a top shield 22 which shield is substantially planar in configuration and includes a peripherally oriented groove 24 there around. The shield 22 is adapted for cooperative engagement with a second shield 26 which shield includes an annular groove 28. Groove 28 is configured to locate and receive groove 24 of shield member 22. The shield 26 further includes a body which substantially corresponds to a U-shaped body having a wall member 30 and a downwardly depending wall 32 for facilitating drainage of oil and containment of tangential dispersion. As is illustrated in FIG. 2, the second shield by virtue of its U shaped configuration effectively contains gear 14 and this augmented by top shield 22.

A third shield 34 is provided. This is referred to as a nut shield and the nut shield is positioned about the tower shaft 12. The nut shield substantially corresponds to a U-shaped profile and is adapted to cooperatively engage shield 26. As illustrated, all of the shields 22, 26 and 34 are coaxially arranged about the upper tower shaft and gear and are maintained in a vertically spaced relationship in order to prevent flow of oil therein, while, at the same time, preventing losses by windage and unwanted dispersion of the oil within the compartment of the engine. The nut shield assists in returning oil to the accessory gear box (not shown).

The above description is meant to be exemplary only, and one skilled in the art will recognize that changes may be made to the embodiments described without department from the scope of the invention disclosed. Still other modifications which fall within the scope of the present invention will be apparent to those skilled in the art, in light of a review of this disclosure, and such modifications are intended to fall within the appended claims.

1. An oil shield for an upper tower shaft gear, comprising:
a plurality of shield members for encapsulating said upper tower shaft gear to reduce the amount of displaced oil from contacting surrounding engine components, said shield members including:
a first shield member adjacent a top surface of said upper tower shaft gear;
a second shield member adjacent an under surface of said upper tower shaft gear and engaged with said first shield member to enclose said upper tower shaft gear; and
a third shield member adjacent said second shield member, said shield members for draining oil in a predetermined pattern.

2. The oil shield as defined in claim 1, wherein at least one shield of said shields is removably mounted to an adjacent shield.

3. The oil shield as defined in claim 1, wherein said first shield member and said second shield member are configured for cooperative engagement.

4. The oil shield as defined in claim 3, wherein said second shield member includes an annular groove within the periphery thereof.

5. The oil shield as defined in claim 4, wherein said first shield includes an annular projection about the periphery thereof for reception within said annular groove of said second shield member.

6. The oil shield as defined in claim 1, wherein said second shield member.

7. The oil shield as defined in claim 4, wherein said second shield member includes a body for facilitating oil drainage.

8. The oil shield as defined in claim 7, wherein said body has a generally U shaped profile for facilitating drainage.

9. The oil shield as defined in claim 1, wherein said third shield member cooperatively engages said second shield member.

10. The oil shield as defined in claim 9, wherein said second shield member has a substantially U shaped profile for positioning coaxially about said tower shaft.

11. The oil shield as defined in claim 1, wherein said shield members are coaxially arranged in vertically spaced relation.

12. The oil shield as defined in claim 1 in combination with a tower shaft having gear means.

13. A method of shielding oil dispersion within an upper tower shaft gear of an aircraft engine, comprising:
providing a plurality of discreet cooperatively engageable shield members;
encapsulating said upper tower shaft gear by positioning said shield members about said upper tower shaft gear; and
securing said cooperatively engageable shield members together to provide an oil shield having a predetermined drain pattern.

14. The method as defined in claim 13, including the step of positioning said shield members in a coaxial relationship about said upper tower shaft gear.

15. The method as defined in claim 13, wherein said plurality of shield members includes a lower shield member for facilitating oil drainage to an accessory gear box of said aircraft engine.

16. The method as defined in claim 15, wherein said plurality of shield members includes an upper shield for cooperative engagement with said lower shield for preventing oil dispersion within the engine compartment of said aircraft.

17. The method as defined in claim 16, wherein said plurality of shield members includes a nut shield for cooperative engagement with said lower shield and for directing oil to said accessory gear box.
